(19) United States
(12) Patent Application Publication
(10) Pub. No.: US 2011/0113476 A1
(43) Pub. Date: May 12, 2011

(54) METHOD AND DEVICE FOR GENERATING A TIME-DEPENDENT PASSWORD

(75) Inventor: Said Moutarazak, Geleen (NL)

(73) Assignee: Vodafone Holding GmbH, Dusseldorf (DE)

(21) Appl. No.: 13/001,525

(22) PCT Filed: Jul. 1, 2009
(86) PCT No.: PCT/EP09/04744

§ 371 Date: Dec. 27, 2010

(30) Foreign Application Priority Data
Jul. 1, 2008 (EP) 08011848.2

(51) Int. Cl. H04L 9/32

(52) U.S. Cl. 726/6

(57) ABSTRACT

There is provided a system and method for generating a time-dependent password in a security device using time information. An exemplary method comprises checking whether the security device has access to an external time signal. The exemplary method also comprises requesting a user of the security device to enter the time information, if it is determined that the security device has no access to the external time signal. The exemplary method additionally comprises generating a time-dependent password using the time information entered in response to the request.

### CROSS-REFERENCE TO RELATED APPLICATIONS

Pursuant to 35 U.S.C. §371, this application is the United States National Stage Application of International Patent Application No. PCT/EP2009/004,744, filed on Jul. 1, 2009, the contents of which are incorporated by reference as if set forth in their entirety herein, which claims priority to European (EP) Patent Application No. 08 011 848.2, filed Jul. 1, 2008, the contents of which are incorporated by reference as if set forth in their entirety herein.

### BACKGROUND

Conventional static passwords bear the risk to be discovered by unauthorized third parties. Protection against unauthorized access to restricted resources can be improved by using so-called one-time passwords (OTPs), which are valid only for one time. An OTP mechanism, commonly referred to as time-synchronised type OTP, involves synchronised time information for generating and validating OTPs. In regular time intervals, such as, for example, every minute, a security device or an application, which is usually called “token”, generates a new OTP from current time information and a secret key assigned to the user. For validating the OTP, an authorisation station re-generates the OTP based on the secret key and own current time information using the same algorithm as the token and compares the self-generated password with the password generated by the token.

In the OTP environment described before, the time information used in the token and the time information used in the authorisation station have to be well synchronised. However, in OTP environments, certain time deviations are allowed, which means that the authorisation station accepts OTPs generated and based on time information that differs from that time of the authorisation station by a predefined time deviation. Typical allowed time deviations may be in the range of one or several minutes, for example.

The token may be a closed, tamper-resistant hardware system dedicated to the generation of OTPs, which stores the secret key of the user and which usually has a built-in clock for providing the time information. As an alternative, the token may be configured as a so-called “soft token”, which is a software application run on a general-purpose processor.

The international patent application WO 2007/126227 describes a mobile communication device, such as, for example, a mobile phone or a PDA (Personal Data Assistant) or the like, which has an interface for accepting an IC chip (IC: Integrated Circuit) for generating time-synchronised type OTPs. The IC chip stores the users secret key and comprises a module for generating the OTPs. The time information is provided by a base station and received by the radio frequency processing unit of the mobile communication device.

The IC chip allows for implementing the token for generating time-synchronised type OTPs in a mobile communication device. An external time signal provides the time information for generating the OTPs, such that a special clock for this purpose can be dispensed with. However, the time information is available only if the mobile communication device is connected to the base station. This means that the generation of OTPs is not possible, if the mobile communication device cannot be connected to the base station.

### SUMMARY

Exemplary embodiments of the present invention relate to the generation of time-dependent passwords, particularly to the generation of time-synchronized one-time passwords. More specifically, an exemplary embodiment of the invention relates to a method for generating a time-dependent password in a mobile communication device. In addition, an exemplary device for generating a time-dependent password in a mobile communication device and an exemplary mobile communication device comprising the device for generating the time-dependent password are contemplated.

One exemplary embodiment provides for generating time-synchronised type OTPs in a device having access to an external time signal, when the device cannot receive the external time signal.

According to an exemplary embodiment of the invention, a method of the type described before is proposed, which comprises the following steps:
checking, whether the security device has access to an external time signal;
requesting a user of the security device to enter the time information, if it is determined that the security device has no access to the external time signal; and
generating a time-dependent password using the time information entered in response to the request.

According to another exemplary embodiment, a device for generating a time-dependent password using time information is contemplated. The exemplary device comprises:
means for checking, whether an external time signal is accessible;
means for requesting a user to enter the time information, if the checking means determines that the external time signal is not accessible, and
means for generating a time-dependent password using the time information entered in response to the request.

In an exemplary embodiment, a time-dependent password can be generated in the absence of the external time signal. This may be achieved by allowing the user of the security device to specify the time information needed for generating a time-dependent password, if no external time signal is received in the mobile communication device.

By allowing the user to input the time information, an exemplary embodiment of the invention contradicts the usual opinion that the mechanism for generating the time information needed for calculating time-dependent passwords is a sensitive component of the password generation, which has to be secured against access by the user. Particularly, it has been discovered that the possibility to generate a time-dependent password based on the time information provided by the user is very useful to bridge a temporarily absence of an external time signal.

However, if the external time signal can be received in the security device, the time signal can be used for generating the time-dependent password. This has the advantage that the risk of fraudulent misuse is reduced.

Therefore, in one exemplary embodiment of the method and the device, the time-dependent password is generated using the external time signal, if it is determined that the security device has access to the external time signal.

In one exemplary embodiment, the time information used for generating the time-dependent password has to be synchronized with the time information used by the authorization station. However, the user may stay in a time zone different from the time zone in which the authorization station is located. If, in this case, the user entered his local time, the generated password would be invalid due to the time difference to the location of the authorization station.

Therefore, in one exemplary embodiment of the method and the device, the user is requested to specify a time zone to which the entered time information refers, the time information entered by the user may be converted to the time zone of an authorization station for validating the password and the time-dependent password is generated using the converted time information.

In another exemplary embodiment of the method and the device, the user is requested to enter an authentication code and the entered time information is only used for generating a time-dependent password, if the authentication code has been validated successfully.

This prevents an unauthorized third party that does not dispose of the authentication code from generating a password and making fraudulent use of it. Particularly, an unauthorized third party is prevented from generating and using a password that is valid in a future point in time.

Furthermore, one exemplary embodiment of the method and the device comprises the steps of:
storing the entered time information;
determining that the security device has access to the external time signal;
checking, whether the entered time information refers to a future point in time compared to the currently received external time signal; and
initiating an alarm routine, if the entered time information refers to a future point in time compared to the currently received time signal.

This provides security against an attack based on the aforementioned generation of a password, which is valid in a future point in time.

In order to prevent an attacker from gaining unauthorized access using such a password, in one exemplary embodiment of the method and the device, the password generated using the entered time information may be marked as invalid in the authorization station in response to the initiation of the alarm routine.

In a further exemplary embodiment of the method and the device, the user is requested to enter a secret key allocated to the user and the time-dependent password is generated using the secret key entered by the user.

Moreover, in one exemplary embodiment of the method and the device, the generated time-dependent password is displayed at the security device and/or the time-dependent password is transmitted from the security device to the authorisation station via a data network to which the security device is connected.

In one exemplary embodiment of the method, a mobile communication device comprises the security device.

Using a mobile communication device comprising a security device for the generating the time-dependent password increases the user convenience, since a user who usually carries a mobile communication device does not need an additional device for generating the time-dependent password.

In one exemplary embodiment of the method and the device, the external time signal may be provided by the communication network to which the security device can be connected. Therefore, in this exemplary embodiment checking, whether the security device has access to the external time signal, comprises checking, whether the security device is connected to a communication network providing the external time signal.

Providing the external time signal in the communication network has the advantage that no additional equipment is needed to access the time signal, if a mobile communication device comprises the security device, since the mobile communication device usually has all components for connecting to a communication network.

In one exemplary embodiment of the invention, the device is a smartcard, which can be connected to a mobile communication device.

Such an exemplary embodiment may provide an advantage that the device can be provided to the user easily in the form of smartcard, which is connectable to his mobile communication device. The usage of a mobile communication device for generating the time-dependent password is especially convenient for the user due to the reasons described before. This exemplary embodiment may also provide an advantage that the security mechanism of the smartcard prevents fraudulent use of the device.

In mobile communication, smartcards may be used for identifying and authenticating a user to a mobile communication network. Advantageously, such smartcards can also host the device according to the invention. Therefore, in one exemplary embodiment of the invention, the smartcard comprises a subscriber identification module for identifying and/or authenticating a user to a mobile communication network.

Furthermore, an exemplary embodiment of the invention may relate to a computer program comprising software code portions for performing a method of the type described before, when the computer program is run on a processor. Such a computer program may be embodied in one or more tangible, non-transitory, computer-readable storage media. Moreover, an exemplary computer program may comprise code that, when executed by a processor, causes the processor to execute a method according to an exemplary embodiment of the present invention.

Moreover, exemplary embodiments of the present invention relate to a mobile communication device comprising a device of the type described herein.

### BRIEF DESCRIPTION OF THE DRAWINGS

These and other aspects of the invention will be apparent from and elucidated with reference to the exemplary embodiments described hereinafter making reference to the accompanying drawings.

FIG. 1 is a block diagram showing a mobile communication device for generating time-synchronised type OTPs, according to an exemplary embodiment of the present invention; and

FIG. 2 is a process flow diagram showing a method for providing time information for generating the time-synchronised type OTPs, according to an exemplary embodiment of the present invention.

### DETAILED DESCRIPTION OF EMBODIMENTS OF THE INVENTION

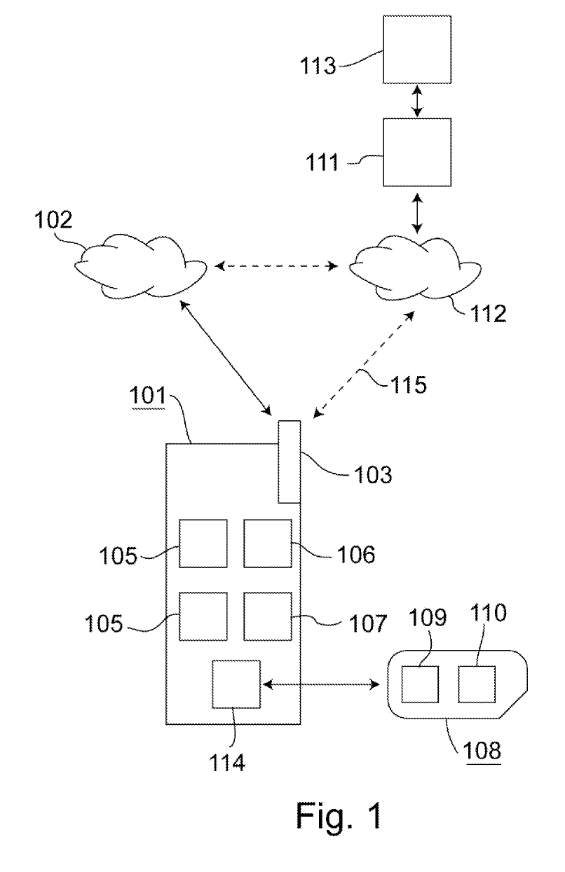

FIG. 1 shows a mobile communication device 101, which can be connected to a mobile communication network (PLMN—Public Land Mobile Network) 102, which may be configured according to the GSM or UMTS standard, for example (GSM: Global System for Mobile communications; UMTS: Universal Mobile Telecommunications System). For connecting the mobile communication device 101 to the PLMN 102, the mobile communication device 101 comprises a radio interface 103. The radio interface 103 is coupled to a main processor 104 for controlling the operation of the mobile communication device 101. For interacting with the mobile user, the mobile communication device 101 comprises an input component 105 and a display component 106 both coupled to the main processor 104. Applications run by the main processor 104 and reference data are stored in a memory component 107 to which the main processor 104 has access.

The mobile communication device 101 interacts with a smartcard 108, which is inserted into a card reader unit 114 of the mobile communication device 101. The smartcard 108 includes a microprocessor 109 and a memory 110 and comprises a subscriber identification module allocated to the user of the mobile communication device 101. Particularly, the subscriber identification module includes information for identifying and authenticating the mobile user to the PLMN 102 and provides functionality for accessing services of the PLMN 102. The subscriber identification module may be configured in accordance with the type of the PLMN 102. If the PLMN 102 is a GSM or UMTS network, the subscriber identification module is a subscriber identity module (SIM) according to the GSM standard or a universal subscriber identity module (USIM) according to the UMTS standard.

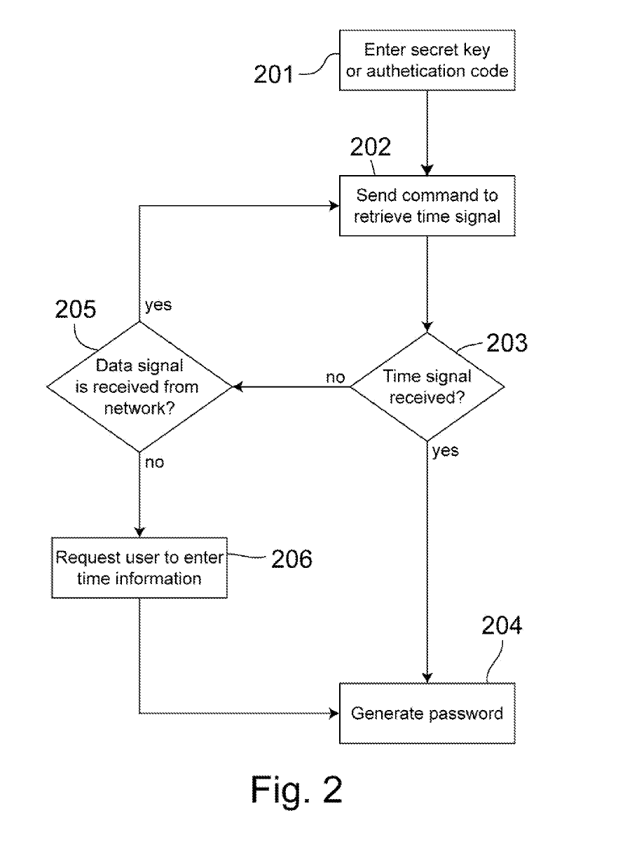

The mobile user has the authorisation to access a restricted resource. In one embodiment, the resource may be a web application or a web service hosted by a network server 113, which is connected to a data network 112. Access to the resource is controlled by an authorisation station 111, which denies access to the resource unless the user is identified and authenticated successfully. The network server 113 may comprise the authorisation station 111, or the authorisation station 111 may reside in another network server. In the embodiment depicted in FIG. 2, the network server 112 is connected to the data network 112 via the authorisation station 111. However, other network architectures are possible.

The authorisation station 111 performs the user authorisation using time-synchronised OTPs. This ensures a relatively high level of security of the access control. Thus, the web application may be a payment application, for example, that has to be secured efficiently against unauthorised access by third parties.

For generating time-synchronised OTPs, the mobile communication device 101 comprises an OTP application. The OTP application may be resident in the mobile terminal and run on the main processor 104 of the mobile communication device 101. In a different embodiment, the OTP application is resident in the smartcard 108 including the subscriber identification module. In this embodiment, the OTP application is stored in the memory 110 and run on the microprocessor 109 of the smartcard 108. This has the advantage that the OTP application is secured against unauthorized access via the security mechanism of the smartcard 108. In further embodiments, an OTP chip including the OTP application may be removably connected to the mobile terminal.

The mobile communication device 101 may be connected to the data network 112 via an access technology, such as, for example, a WLAN connection. In FIG. 1, this is schematically illustrated with the arrow 115. In this architecture, the mobile user may access the network server 113 using the mobile communication device 101 and OTPs generated in the mobile communication device 101 may be transmitted electronically from the mobile communication device 101 to the authorisation station 111. Furthermore, the PLMN 102 may be coupled to the data network 112, such that the mobile communication device 101 can be connected to the data network via the PLMN 102, if it is registered in the PLMN 102.

In another embodiment, the mobile user accesses the network server 113 using a further device connected to the data network 112, such as, for example, a personal computer. In this case, the OTP application outputs generated passwords at the mobile communication device 101. The user reads that generated password at the display component 106 of the mobile communication device 101 and enters the password at the device used for accessing the network server 113.

The OTP application provides a graphical user interface at the display component 106 of the mobile communication device 101 for depicting outputs to the user and for presenting input requests to the user. Moreover, the OTP application is configured to receive user inputs from the input component 105 of the mobile communication device 101. If the OTP application resides in the smartcard 108, the OTP application may access the functionalities of the mobile communication device 101 using SIM Toolkit commands, which, in general, are known to a person skilled in the art.

For generating time-synchronised OTPs, an algorithm is implemented in the OTP application, which is used to calculate OTPs based on time information and a secret key allocated to the user. The secret key may be a personal identification number (PIN), for example. The secret key may be entered by the user, when the OTP application is started or when the user requested the generation of a password. Likewise, it is possible that the secret key is stored securely in the mobile communication device 101, particularly in the smartcard 108. In this embodiment, the generation of a password may be possible only after an authorisation code entered by the user has been validated successfully by the OTP application. The authorisation code may be another PIN and differs from the secret key allocated to the user in that the secret key is used to calculate the passwords, while the authorisation code is used to unlock the password generation. Securing the OTP application with an authorisation code for unlocking the password generation has the advantage that an attacker has to use the mobile communication device 101 for generating passwords of the user, since the secret key is secured against access within the mobile communication device 101.

For validating the password generated by the OTP application, the authorisation station 111 re-computes the passwords using the user's secret key, which is also stored in the authorisation station 111, and its own time information. The time information used by the OTP application and the time information present in the authorisation station 111 have to be synchronised accurately enough. Usually, the authorisation station 111 allows for generating passwords computed using a time information with a predetermined deviation from the time information present and authorisation station 111. For this purpose, the authorisation station 111 determines that the password is valid, if it is calculated using a time from a predetermined time interval around the current time of the authorisation station 111. The time interval may be between 1 and 15 minutes, preferably between 2 and 4 minutes.

The OTP application retrieves the time information needed for generating the time-synchronised OTPs from the PLMN 102. For this purpose, the PLMN 102 includes a supplementary service providing a time signal. The service may be accessed using so-called USSD commands (USSD: Unstructured Supplementary Service Data), which are, in general, known to a person skilled in the art in general. However, retrieving the time information from the PLMN 102 requires that the mobile communication device 101 was connected to the PLMN 102. This is not always true, since it may happen that the mobile communication device 101 is out of coverage of the PLMN 102, for example. Therefore, the OTP application requests the user to enter time information into the mobile communication device 101, in case no time information can be received from the PLMN 102.

In one embodiment, a method schematically depicted in FIG. 2 is implemented in the OTP application for this purpose: After the user has entered his secret key or his authorisation code in step 201, the OTP application sends a command to retrieve time information from the PLMN 102 in step 202. The command is passed to the radio interface 103 of the mobile communication device 101, which transmits the command to the PLMN 102, if the mobile communication device 101 is connected to the PLMN 102. After having passed the command to the radio interface 103 the OTP application checks, whether the command is responded within a predetermined time interval in step 203. This means that the OTP application checks, whether the time signal is received during the time interval. If the time signal is received in time, the OTP application computes a password based on the received time information and the secret key of the user in step 204.

If the OTP application determines in step 203 that no time information has been received from the PLMN 102 in the predetermined time interval, the OTP application checks, whether the mobile communication device 101 is connected to the PLMN 102 in step 205. This may be done by checking, whether the mobile communication device receives a predetermined data signal broadcasted in the PLMN 102, such as, for example, a signal identifying the PLMN 102. If it is determined in step 205 that the mobile communication device 101 is registered in the PLMN 102, the OTP application preferably goes back to step 202 and resends the command to retrieve the time information. However, if it is determined in step 205 that the mobile communication device 101 is not connected to the PLMN 102, the OTP application requests the user to enter time information at the mobile communication device 101. After having received the user input, the OTP application calculates a password using the time information specified by the user in step 204.

For requesting the user to input the time information, the user interface of the OTP application presented at the display component 106 of the mobile communication device may provide an input field, which may be filled in by the user using the input component 105 of the mobile communication device 101. The user may receive the time information from any available source. For example, this may be his wristwatch or a public watch in the vicinity of his position.

In order for the calculated password to be valid, the password has to be calculated using the time information present in the authorisation station 111. Particularly, this means that the time information used for the calculation should refer to the same time zone as the time information of the authorisation station 111. Therefore, in one embodiment, the user is requested to input a time information referring to the time zone of authorisation station 111 in step 206. This requires knowledge about the time zone of the authorisation station 111 and about the time shift between this time zone and the current time zone of the user.

In another embodiment, the user is requested to input his local time and to specify his current time zone. For the specification of the time zone, a list of the existing time zones may be presented to the user, such that the user can specify his time zone by choosing it from the list. Using the time information entered by the user and the information about the time zone the time information refers to, the OTP application calculates the local time of the authorisation station 111 and uses this calculated time to generate the password in step 204.

In order to prevent that an attacker uses the mobile communication device 101 to generate a password that will be valid in the future by inputting time information relating to a future point in time, the input of the time information by the user may be secured by an authorisation code. This means that the OTP application requests the user to enter the authorisation code besides the time information. The authorisation code is also stored securely in the mobile communication device 101, particularly in the smartcard 108. In this embodiment, the OTP application validates the authorisation code before generating a password using the time information given by the user.

Furthermore, in one embodiment, the OTP application stores at least the time information, when it calculates and outputs a password based on time information specified by the user. Particularly, the time information may be stored securely in the smartcard 108. After having stored the time information, the OTP application monitors, whether the mobile communication device 101 connects to the PLMN 102 again. This may be done by sending commands to retrieve time information from the PLMN 102 or by checking in regular time intervals, whether a predetermined data signal broadcasted in the PLMN 102 is received in the mobile communication device 101. Again, this data signal may be a signal identifying the PLMN 102 that is broadcasted in the PLMN in regular time intervals.

If the OTP application determines that the mobile communication device 101 is connected to the PLMN 102 again, the OTP application checks, whether the time information used for calculating the password refers to a future point in time. If this is true, an alarm routine is started, since in this case an attacker might have generated the password for fraudulent use in the future. For the aforementioned check, the OTP application compares time information currently retrieved from the PLMN 102 and the stored time information. If it is determined that the stored time information referred to the future compared to the currently received time information, the OTP application starts the alarm routine.

The alarm routine may comprise informing the user that a password has been generated for a future point in time. If the user judges that the password might have been generated for fraudulent use, he may inform the authorization station 111. In another embodiment, the OTP application may inform the authorization station 111 automatically. For this purpose, the OTP application may generate a corresponding message specifying the time information in question, and the OTP application may control the mobile communication device 101 to transmit the message to the authorisation station 111. The message may be transmitted to the authorisation station 111 via the PLMN 102 or via another data connection between the mobile communication device 101 and the authorisation station 111.

After having been informed about the possible misuse, steps can be taken in the authorisation station 111 to prevent an unauthorised access to the network server 113 using the password in question. This may be done by blocking access to the network server 113 with this password. Particularly, the password generated for the future point in time may be marked as invalid, such that this password cannot be used as an authorisation for accessing the network server 113.

While exemplary embodiments of the invention have been illustrated and described in detail in the drawings and foregoing description, such illustration and description are to be considered illustrative or exemplary and not restrictive; the invention is not limited to the disclosed embodiments. Particularly, the invention is not limited to a download of an application or program code to smartcard 106. A person skilled in the art recognises that other data can be downloaded to the smartcard 106 in the same way as it has been described before in connection with the download of a program code of an application. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single processor or other unit may fulfill the functions of several items recited in the claims. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1-15. (canceled)

16. A method for generating a time-dependent password in a security device using time information, the method comprising:
checking whether the security device has access to an external time signal;
requesting a user of the security device to enter the time information, if it is determined that the security device has no access to the external time signal; and
generating a time-dependent password using the time information entered in response to the request.

17. The method recited in claim 16, wherein the time-dependent password is generated using the external time signal, if it is determined that the security device has access to the external time signal.

18. The method recited in claim 16, comprising:
requesting the user to specify a time zone to which the entered time information refers;
converting time information entered by the user to a time zone of an authorization station for validating the password; and
generating the time-dependent password using the converted time information.

19. The method recited in claim 16, comprising:
requesting the user to enter an authentication code; and
using the entered time information for generating the time-dependent password only if the authentication code has been validated successfully.

20. The method recited in claim 16, further comprising:
storing the entered time information;
determining that the security device has access to the external time signal;
checking, whether the entered time information refers to a future point in time compared to the currently received external time signal; and
initiating an alarm routine, if the entered time information refers to a future point in time compared to the currently received time signal.

21. The method recited in claim 20, comprising marking the password generated using the entered time information as invalid in the authorization station in response to the initiation of the alarm routine.

22. The method recited in claim 16, comprising:
requesting the user to enter a secret key allocated to the user; and
generating the time-dependent password using the secret key entered by the user.

23. The method recited in claim 16, comprising:
displaying the generated time-dependent password at the security device; and
transmitting the time-dependent password from the security device to the authorisation station via a data network to which the security device is connected.

24. The method recited in claim 16, wherein the security device comprises a portion of a mobile communication device.

25. The method recited in claim 16, wherein checking whether the security device has access to the external time signal comprises checking whether the security device is connected to a communication network providing the external time signal.

26. One or more tangible, non-transitory, computer-readable media storing a computer program that generates a time-dependent password in a security device using time information, the computer program including machine-readable code that, when executed by a processor, causes the processor to:
check whether the security device has access to an external time signal;
request a user of the security device to enter the time information, if it is determined that the security device has no access to the external time signal; and
generate a time-dependent password using the time information entered in response to the request.

27. A device for generating a time dependent password using time information comprising:
means for checking, whether an external time signal is accessible;
means for requesting a user to enter the time information, if the checking means determines that the external time signal is not accessible; and
means for generating a time-dependent password using the time information entered in response to the request.

28. The device recited in claim 27, wherein the device is a smartcard, which can be connected to a mobile communication device.

29. The device recited in claim 28, wherein the smartcard comprises a subscriber identification module for identifying and/or authenticating a user to a mobile communication network.

30. The device for generating the time dependent password recited in claim 27, wherein the device for generating the time dependent password comprises a portion of a mobile communication device.
